(19) United States
(12) Patent Application Publication
(10) Pub. No.: US 2023/0415757 A1
(43) Pub. Date: Dec. 28, 2023

(54) DATA PROCESSING NETWORK FOR PERFORMING DATA PROCESSING

(71) Applicant: Robert Bosch GmbH, Stuttgart (DE)

(72) Inventors: Raphael Diziol, Kandel (DE); Michael Poehnl, Wurmberg (DE); Stefan Egenter, Freiburg (DE)

(21) Appl. No.: 18/249,480

(22) PCT Filed: Oct. 15, 2021
(86) PCT No.: PCT/EP2021/078590

§ 371 Date: May 11, 2023

(30) Foreign Application Priority Data
Oct. 22, 2020 (DE) 10 2020 213 323.9

(51) Int. Cl. B60W 50/023; G06F 11/16

(52) U.S. Cl. CPC B60W 50/023; G06F 11/1641

(57) ABSTRACT

A data processing network for the redundant and validated carrying out of successive data processing steps, each used to generate output data from input data. Output data of a first data processing step are at least partially simultaneously input data of a further data processing step. At least a first and a second data processing module carry out each data processing step. The data processing network further comprising a comparator module. The first data processing modules and the second data processing modules transmit control parameters of the individual data processing steps to the comparator module. The comparator module compares corresponding control parameters that were transmitted by the first and second data processing modules. Based on this comparison, the comparator module provides at least one synchronized control parameter that contains an item of control information relating to at least one data processing step that has been carried out.

### BACKGROUND INFORMATION

Systems for driver assistance or automated driving are made up of many individual software units that can usually be described with graphs with regard to the data flow. These software units (often also called runnables, nodes, or data processing components) are characterized by the processing of a set of input data and the generation therefrom of a set of output data.

In the aforementioned systems, input data from sensors such as radar or video are processed in a graph of data processing components that visualizes the data flow in a static view.

The various software units regularly form a complex data processing network with which sensor data are processed in order to perform actions based on the sensor data. Such actions can be, for example, control tasks in the context of autonomous driving operation of a vehicle. The data processing in the data processing network typically includes a plurality of data processing steps or data processing tasks that build on one another, carried out with the data processing components.

As part of the functional safety requirements for driver assistance systems and (highly) automated driving (HAD), the probability of systematic and sporadic hardware errors must not exceed a specified frequency that stands in relation to the risk and the expected damage to the system functions. Because newly developed driver assistance systems are regularly in use in a large number of vehicles in parallel with each other, and the risk has to be evaluated in relation to the entire correspondingly equipped vehicle fleet, the acceptable probability of the occurrence of hardware errors is extraordinarily low.

Compared to today's high-end processors, the processing power of standard available microcontrollers that fulfill this safety level is very limited. Their maximum clock speed is about 10% (300 MHz vs. 3 GHz) and they lack internal optimizers, which are standard in off-the-shelf microprocessors (ρP) and play a large role in their performance.

Based on this, a novel approach for constructing a data processing network for a motor vehicle is provided, which addresses a solution for the limited computing power of standardly available microcontrollers for such safety levels.

### SUMMARY

An example embodiment of the present invention provides a data processing network for the redundant and validated carrying out of a plurality of successive data processing steps, each of which is used to generate output data from input data, output data of a first data processing step being at least partially at the same time input data of a further data processing step, at least a first data processing module and a second data processing module being provided for the carrying out of each data processing step, the data processing network further having a comparator module, the first data processing modules and the second data processing modules being designed to transmit control parameters of the individual data processing steps to the comparator module and the comparator module being designed to perform at least one comparison of corresponding control parameters that were transmitted by the first data processing modules and the second data processing modules and, based on this comparison, to provide at least one synchronized control parameter that contains an item of control information relating to at least one performed data processing step.

In the data processing network of the present invention, it is made possible to realize a software lockstep based on hardware that does not inherently meet the corresponding requirements (e.g. ASIL-D compliance). This is successful in particular for data processing networks whose data processing requires high levels of computing power, for which hardware with very high performance is usually required.

According to an example embodiment of the present invention, the first data processing module and the second data processing module, respectively separate hardware (cores separate from each other) are used, which have high computing power and both perform the same computation. The comparator module carries out a comparison of the calculations, and only in the case of equality of the calculation result is this result used for further data processing in the data processing network. The equality is monitored by the data processing module on the basis of the control parameters and the synchronized control parameter is used in the data processing network to control the data processing control flow.

The points at which the first data processing module and the second data processing module provide the control parameters in order to then forward them to the comparator module are standardly also referred to as synchronization points.

As already explained, the method described here relates to a so-called software lockstep. A software lockstep is to be distinguished from a hardware lockstep. Significantly more complex hardware is required for a hardware lockstep.

The hardware lockstep is regularly implemented in such a way that hardware is used that executes each calculation step of the software programs operated on it twice. This means that the software program itself runs only once on the hardware. An operating system sees only one instance of the respective software program. The hardware executes every step of the software twice below the one operating system level.

In contrast, according to an example embodiment of the present invention, the software lockstep described here means that the program is executed twice, namely twice at the operating system level. If necessary, two independent operating systems (a first operating system on the first data processing module with a first hardware/core and a second operating system on the second data processing module with a second hardware/core) can also be operated, which execute the respective data processing steps in each case (and thus twice).

A software lockstep can also be operated on an operating system, in which case the instruction to use different hardware (two different cores) for the double execution is given at the operating system level if necessary.

As soon as there are two instances that can be replicated/reproduced without hardware changes, the double execution is a so-called software lockstep. A hardware lockstep always means that for an additional redundant execution additional hardware (circuits, transistors, etc.) also has to be required that are located below the operating system level and that are not recognizable by the operating system as being separate from each other, but rather appear to be one hardware unit from the operating system's point of view. By using a hardware lockstep, therefore, at least twice the number of transistors is always required to achieve the same performance as without a hardware lockstep.

Through the data processing network according to the present invention, or with the data processing network according to the present invention, a lockstep approach is also possible on controllers/processors that were not specifically developed for this purpose.

The normal case, however, is that the first data processing module and the second data processing module are realized with identical software, and identical hardware (identical cores) is also used with regard to their specification. As long as the respective data processing module or the underlying hardware is functioning correctly, the same input data in both data processing modules will produce the same output data.

If a software lockstep is used for (near-) real-time applications, many conventional architectures are based on time-slice grids, in which the processing of the calculation steps must in no case exceed the specified frame. In this context, one often speaks of the so-called WCET (Worst Case Execution Time). Which computing steps are executed in which sequence in the time slices is here determined a priori. Since the calculation steps are known in advance, the two units used can perform the calculation steps in parallel. There is often a high degree of variability in how large the computation expense is for processing input data to generate output data. An example is the case of an image analysis to determine all visible traffic signs. For example, a data processing step for carrying out such an analysis takes a much longer time if a hundred traffic signs are visible at the same time than if only two traffic signs are in the field of view. In a standard software lockstep approach, time slices would have to be designed on the basis of a WCET in such a way that sufficient time is provided to perform the data processing step for all possible relevant cases in every case.

In comparison, data-driven systems are more flexible in which however the execution order may be a function of the result and duration of the previous calculations. The order of the calculation steps is then no longer known a priori. For a SW lockstep, this property means that possible branching points must always also be synchronization points. If the computing units are used in parallel, the result of one calculation step always has to be validated before the next step can be reliably determined and executed.

Therefore, for data-driven architectures it can be more efficient not to compute in parallel, but to let one computational unit run ahead (without synchronization) and to recompute and verify the achieved result—with specification of the identical execution order—on the other units. Thus, in this case there is a primary module that specifies the calculation on the lower-level secondary modules.

Today's hardware lockstep-capable microcontrollers do not meet the computing power requirements needed for highly automated driving; at the same time, current high-performance processors do not meet the required ASIL-D safety ratings.

In order to nonetheless obtain a computing system for highly automated driving, a way must be found to secure the fast but unsafe processors in a corresponding manner. For this purpose, here it is proposed to use a software lockstep.

The simplest way to try this would be to implement the software lockstep on a corresponding microprocessor. However, this would not only (at least) halve its computing power, but would also have two serious problems: on the one hand, systematic errors in redundant computing on the identical hardware could not be excluded, and on the other hand a necessary comparator for comparing the output data/computation results would also run on the unsecure hardware, for which reason one could not trust the results sufficiently.

To solve this problem, according to an example embodiment of the present invention, it is provided to implement a software lockstep based on at least two modules with separate hardware and a comparator unit (comparator module), where the comparator unit/module runs on additional ASIL-D-compliant hardware.

Since in the approaches described above the maximum required computing time must be kept available taking into account a WCET, but this is typically only required in exceptions, in most steps time is “left over,” which sums to form an unacceptable latency over the processing chain of the system and leads to a worse utilization of the hardware. The danger with a parallel software lockstep with an execution order defined a priori and the use of WCET is therefore that the required maximum latency cannot be achieved or undershot in the overall system.

A much better use could be achieved with a data-driven architecture, such as the one above built with a primary module and post-computing secondary modules. In such an architecture, the next data processing step in each case is executed ad hoc; the exact sequence does not have to be known a priori and thus there is a high degree of flexibility.

However, such an architecture has disadvantages in particular for the automotive applications described here, which will be briefly explained below:

The execution sequence is specified by the primary module. The dependent secondary modules recalculate “blindly,” so to speak. Therefore, the order of execution can be checked—if at all —only on the basis of invariants or general rules. This results in the same security rating for the control flow as for the respective hardware used, individually. A high ASIL-D level cannot be achieved with such architectures. In other words: It is possible to determine afterwards, by recalculation with the secondary modules, that the calculations in the primary module could have been faulty—but then it is already too late, because the results of the calculations would already have been needed previously.

The comparison of the calculations can always take place only after the completion of the redundant calculation step and the subsequent communication of results. The time until an error in the calculation is noticed has doubled as a result of the design. This results in an increased error latency, and possibly also unnecessary latency in the regular sequence.

That is, conventional approaches of a lockstep with primary module and secondary module(s) allow a more flexible and data-driven execution, but also have the problem of increased latency.

The presented data processing network and data processing methods implemented therewith according to example embodiments of the present invention enable adequate performance for highly autonomous driving. The presented data processing network enables a combined time-driven as well as data-driven architecture. That is, compared to approaches with an a priori defined execution order, it is possible to have a flexible execution order in the software lockstep.

For this purpose, a software lockstep approach is chosen that is carried out in parallel but is not based on time slices, which approach is realized on at least two microprocessors (the first data processing module and the second data processing module) as computation units and a control component that runs on an additional trusted hardware (the comparator module).

This control unit, which complies with the safety target standard, synchronizes the sequence on the computing units and compares their results.

Compared to the primary/secondary module lockstep, the redundant computation steps are processed (quasi-) simultaneously, thus resulting in no cascade and thus better latency behavior (see FIG. 3).

Instead of sending the complete data packets to the comparator, it is also possible in the data processing network described here to transmit only the cross-sums of the data (packets) as control parameters from the data processing modules to the comparator module, which can significantly reduce the communication outlay.

These optimizations and the mixed, i.e. data- and time-driven, operation result in a good and efficient utilization of the hardware.

From the point of view of a safety architecture, the structure of the described data processing network corresponds to the decomposition of a safety-critical task. This results in a reduced ASIL requirement for the individual computing units, so that an ASIL-D classification of the overall system can be achieved already with high-performance processors that exist today.

To be able to apply the described data processing network for the execution of a software, the following preconditions hold:
All data events and all relevant control events are mapped onto a timeline or an equivalent structure, such as an event queue. The timeline can also be referred to as the common logical timeline.
Each calculation step started by a control event is data-deterministic. That is, given the same start state, identical input data always result in the same output data.

According to an example embodiment of the present invention, it is particularly advantageous if the comparison of the control parameters includes an identity check, and a synchronized control parameter require an identity of the control parameters from the first data processing module and the second data processing module.

Furthermore, according to an example embodiment of the present invention, it is advantageous if the data processing network is set up to use synchronized control parameters provided by the comparator module to control a further data processing of the output data with further data processing steps of the data processing network.

Furthermore, according to an example embodiment of the present invention, it is advantageous if the synchronized control parameter is a validity parameter which contains an item of validity information relating to at least one performed data processing step.

Moreover, it is advantageous according to an example embodiment of the present invention if the data processing network includes at least one sequentialization module, which is set up in each case to sort and synchronize control parameters from the data processing modules and/or the data processing steps and to then forward these, with a sorting, to the comparator module, so that the comparator module can ascertain synchronized control parameters independently of the order in which the data processing modules have carried out the data processing steps.

The sequentialization module is used in particular to track the sequence in which data processing steps are completed in the individual data processing modules and in particular on the hardware available in each case. In this way, the availability of the hardware to perform further data processing tasks can be determined. The sequentialization module is assigned to the data processing module in each case and transmits the control parameter to the comparator module or the (third) hardware component on which the comparator module is operated.

In addition, there is preferably a synchronizer that synchronizes the control parameters that belong together of the two data processing modules with each other (which parameters correspond exactly as long as no error has occurred) and, if necessary, forms control parameter tuples that are supplied to the comparator module. The synchronizer and the comparator module preferably together form a central unit that is operated on a (third) hardware component. Through the synchronizer, flexibility is achieved in the order of execution of the data processing steps. The hardware of the respective data processing module can also be used (when this hardware has finished carrying out a data processing step) to perform further data processing steps.

Since the same data processing step is carried out on the first data processing module and the second data processing module, when the process is successful the same control and data events are generated on each as on the other, but may be generated in a different sequence due to the parallel processing on the units.

The central unit (made up of comparator module and synchronizer) now temporarily stores events (control parameters) until the fitting event (the corresponding control parameter) has arrived from all data processing modules. The control parameters that belong together can then be compared and evaluated if they are the same, or the synchronized control parameter can be outputted.

Preferably, there is also a task distribution module, which then subsequently plans and orders the start of the individual (next) data processing steps on the respective hardware when synchronized control parameters from the hardware module are present, so that a particularly good utilization of the hardware can be achieved.

The task distribution module preferably provides some kind of stimuli to the individual data processing modules to activate them. By using the central unit or the third hardware component and the comparator module, a slight increase in latency between the execution of two data processing tasks does occur. Overall, however, this increase in latency is acceptable, especially compared to standard primary/secondary module architectures.

For the case in which the central unit or the synchronizer and the sequentialization modules and the comparator module cannot determine an unambiguous sequence of the received control parameters/events, an error case can be determined. Depending on the application, this may result in a further recalculation or a termination of the data processing with the data processing network.

Stimuli are discovered by the central unit in a certain way. Whenever a correct calculation result has been determined by the comparator module by comparing control parameters and a synchronized control parameter was able to be calculated, a stimulus has been found, so to speak, that triggers further data processing that requires, as input data, output data calculated with the respective first data processing module and the respective second data processing module. In order to find possible stimuli for the carrying out of further calculation steps, the central unit evaluates not only all received data events (control parameters), but also events that stand for the termination of a previous calculation step (‘End’ or ‘DistributeSamples’).

In addition, time events can be generated as stimuli for a time-driven execution.

In a sense, the central unit manages the common logical timeline, described above, of the data processing.

In case of success, this results in a result-identical process on all computing units, data-driven as well as time-driven, despite possible differences in the local execution sequences.

According to an example embodiment of the present invention, it is advantageously if first data processing modules are realized with first hardware components and second data processing modules with second hardware components, where first hardware components and second hardware components are physically separated from each other.

According to an example embodiment of the present invention, it is also advantageous if at least one of the data processing modules has a hardware component that is not ASIL-D compliant.

According to an example embodiment of the present invention, it is particularly advantageous if both hardware components of the data processing modules are not ASIL-D compliant.

Furthermore, according to an example embodiment of the present invention, it is advantageous if the comparator module is realized with third hardware components, which is physically separated from the first hardware components and the second hardware components.

In this context, it is advantageous if the third hardware component is ASIL-D compliant.

According to an example embodiment of the present invention, it is also advantageous if the comparator module has a data memory (FIG. 3, 15) in which ascertained control parameters are stored with time information, so that a logical timeline results which maps the sequence of the processing of the data processing steps with the data processing modules of the data processing network.

In this context, it is also advantageous if a hardware component of the data processing modules is significantly more powerful than a hardware component of the comparator module. The possible performance differences between the third hardware component of the comparator module and the (first and second) hardware components of the data processing modules are based on the particular application of the data processing network. It is common, for example, for a processor clock of the first and second hardware components to be at least 5 times, or even 10 times, as large as the processor clock of the third hardware component.

In order to relieve the load on the communication path between the data processing modules and the central unit (comparator module and, possibly, sequentialization module and task distribution module), for large amounts of data as output data control parameters can be calculated as their cross-sum (CRC), if necessary, and only these are sent to the comparator module as control parameters together with the unique packet identification (also called meta-sample). The actual flow of output data of one data processing step as input data to the next data processing step can take place on the first hardware component and the second hardware component (and possibly also on further hardware components) independently of each other or in parallel with each other; here data transfer interfaces may exist between different hardware components that are also independent of the central unit or the comparator module. The central processing unit or the comparator module then does not check the original data but rather, for example, their cross-sums, which leads to a bit-by-bit comparison of the original content. It is to be noted that the first hardware component and the second hardware component must buffer the original data packets until they are confirmed by the comparator and can be delivered.

Because the calculation of cross-sums proposed here as control parameters for provision to the comparator module also represents a non-negligible consumption of resources, it is also possible, depending on the amount of data of the output data, for it to be decided whether a direct comparison of the output data or a comparison of cross-sums of the output data is carried out.

According to an example embodiment of the present invention, it is particularly advantageous if the comparison of the control parameters includes a check of whether an error that occurred during data processing in the first data processing module and/or in the second data processing module is below a tolerance limit, and in this case the synchronized control parameter is generated. This means in particular that in such cases the synchronized control parameter is generated if necessary, even though an error has occurred which however is below the tolerance limit.

Also provided herein is a method for operating a described data processing network. According to an example embodiment of the present invention, the method includes at least the following steps:
(a) carrying out a data processing step with a first data processing module and generating a first control parameter that is suitable for checking the carrying out of the data processing step with the first data processing module,
b) independently of step a), carrying out the same data processing step with a second data processing module and generating a second control parameter that is suitable for checking the carrying out of the data processing step with the second data processing module;
c) carrying out a comparison of corresponding control parameters transmitted by the first data processing module and the second data processing module with a comparator module, and, based on this comparison, providing at least one synchronized control parameter that contains an item of control information relating to at least one performed data processing step.

The data processing network described and the technical environment are explained below on the basis of the figures. The figures show preferred exemplary embodiments, which are not limited to the disclosure. The figures are only schematic, and they each illustrate individual aspects of the described data processing network.

### BRIEF DESCRIPTION OF THE DRAWINGS

FIG. 1 shows a described data processing network, according to an example embodiment of the present invention.

FIG. 2 shows a processing of the individual data processing steps on a logical timeline, according to an example embodiment of the present invention.

FIG. 3 shows the processing of a single data processing step with the various data processing modules, according to an example embodiment of present invention.

FIG. 4 shows a flow chart of the method according to an example embodiment of the present invention.

### DETAILED DESCRIPTION OF EXAMPLE EMBODIMENTS

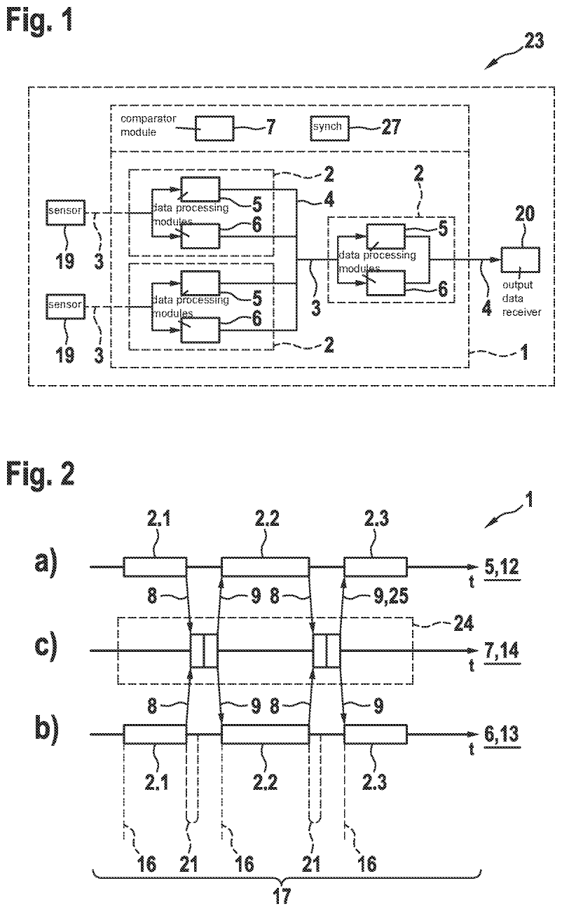

FIG. 1 shows a described data processing network 1 in a motor vehicle 23. As an example, it is shown here that data processing network 1 is used to process data from sensors 19 and an output data receiver 20 is supplied with data by the system. Such an output data receiver 20 can be, for example, a system for autonomous driving or a similar system. Data processing network 1 is used for example to reduce the sensor data to parameters significant for decisions, which can be output data 4 of data processing network 1.

With data processing network 1, hardware components are also included here on which data processing network 1 or its components and modules can be operated.

Data processing network 1 performs individual data processing steps 2 that build on each other. Output data 4 of a data processing step 2 can be input data 3 of a further data processing step 2. Each data processing step 2 is implemented here with a plurality of data processing modules 5,6, realized as independently of one another as possible. Shown here are a first data processing module 5 and a second data processing module 6, respectively. More than two data processing modules that perform a data processing step 2 (in parallel) may also be provided.

Data processing network 1 also includes further components, explained in further detail on the basis of the further figures. This includes in particular comparator module 7 and possibly also a synchronizer 27, which are indicated here only schematically.

FIG. 2 selects another representation of the described data processing network 1. In FIG. 2, three arrows are shown below each other, defining the individual hardware components and at the same time representing the individual method steps a), b) and c) of the described method. The arrows simultaneously provide a representation of the processes on the respective hardware components on a logical timeline 17. The upper arrow is a first hardware component 12 on which first data processing modules 5 are implemented. The lower arrow is a second hardware component 13 on which second data processing modules 6 are implemented. The middle arrow is a third hardware component 14 on which comparator module 7 is realized. Data processing steps 2 of data processing network 1 are carried out in first data processing modules 5 and second data processing modules 6, respectively. Whenever a data processing step 2 is completed, a control parameter 8 is transmitted to comparator module 7, which then detects whether data processing step 2 was executed correctly (i.e. without errors) by comparing the control parameters 8. Comparator module 7 then generates synchronized control parameters 9 that are used to trigger further data processing steps 2, which then further process output data (not shown here) from previous data processing steps 2. Comparator module 8 and its associated components may also be understood as the central unit 24 of the described data processing network 1. The synchronized control parameters 9 can be understood as stimuli 25 for the triggering of further data processing steps 2.

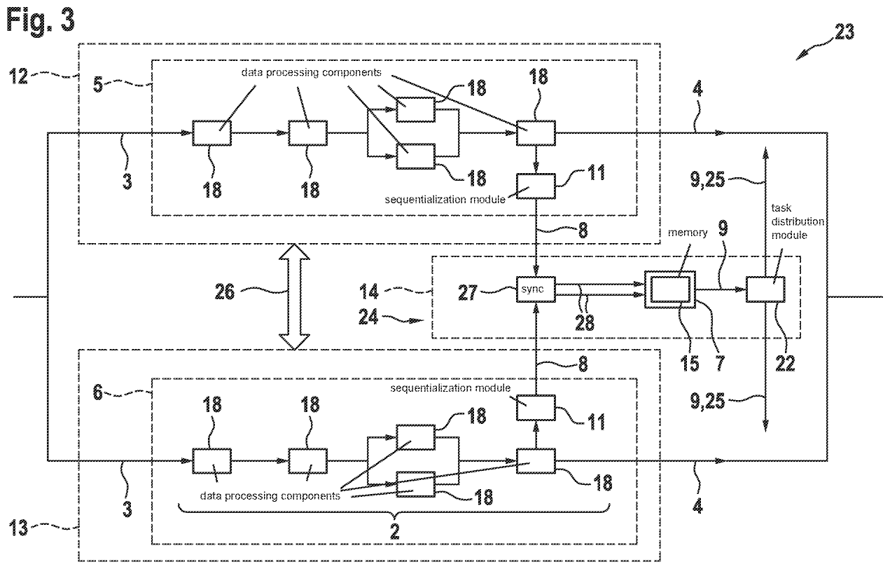

In FIG. 3, the parallel processing of a data processing step 2 by a first data processing module 5 and by a second data processing module 6 is shown in more detail. It can be seen that first data processing module 5 is realized on a first hardware component 12, while second data processing module 6 is realized on a second hardware component 13. First data processing module 5 and second data processing module 6 each process the same input data 3, and it should also generate the same output data 4 in each case.

A data processing step 2 or a data processing module 5, 6 can be further internally subdivided into a plurality of individual data processing components 18, each of which relates to substeps of the data processing. Thus, the data processing step 2 or the data processing module 5, 6 as defined herein already, depending on the application, relate to appropriately selected or determined pre-groupings of substeps that are executed with the data processing components 18. The pre-grouping of substeps is preferably selected such that no data storage within a data processing step 2 or a data processing module 5,6 is required, and for the execution in particular no data other than the input data are accessed.

First data processing module 5 and second data processing module 6 each generate control parameters 8 that are evaluated by comparator module 7. Comparator module 7 is realized on a third hardware component 14, which is independent of first hardware component 12 and second hardware component 13, that forms a central unit 24 and that preferably provides the further higher safety level (higher ASIL level), already described above, of the embodiment. In preferred variant embodiments, a sequentialization module 11 for obtaining the control parameters 8 from the data processing is also connected upstream of each data processing module 5, 6, and a synchronizer 27 is also connected upstream of the comparator module 7 here. In addition, a task distribution module 22 may be connected downstream of comparator module 7, which distribution module outputs synchronized control parameters 9 or stimuli 25 for triggering further data processing steps 2. Synchronizer 27, comparator module 7, and task distribution module 22 can be realized together on third hardware component 14 as the described central unit 24. Preferably, the described data processing network 1 is operated in such a way that data processing steps 2 are executed on the respectively available and not fully utilized hardware. Task distribution module 22 can bring about this distribution of the data processing steps 2 to the available hardware. In addition, the execution of the performed data processing steps 2 takes a different amount of time on each hardware. A sorting of the incoming control parameters 8 is achieved by synchronizer 27, so that comparator module 7 compares the correct control parameters 8 with each other to produce correct synchronized control parameters 9 even when there is a high loading of the hardware. For this purpose, the control parameters 8 are transmitted as control parameter tuples 28 from synchronizer 27 to comparator module 7. It is not necessary for input data 3 and output data 4 each to be transferred from one data processing step 2 to the next data processing step 2 via central processing unit 24 or comparator module 7, respectively. For this purpose, additional data transfer interfaces 26 may also exist between data processing modules 5,6 or the respective hardware components 12, 13, which exist independently of comparator module 7. Data provided via these data transmission interfaces 26 are preferably accessed when, with the aid of the comparator module 7, an error-free processing of the respective data processing step 2 that generates output data 4 has been determined in both data processing modules 5, 6.

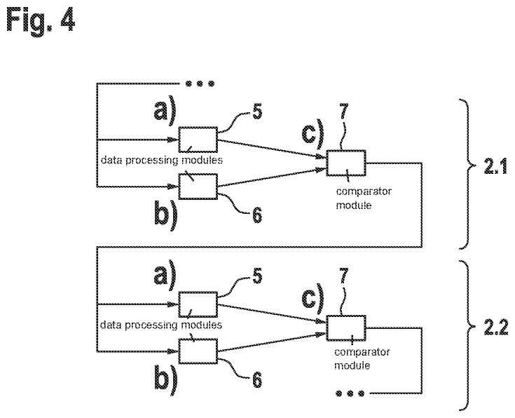

In FIG. 4, another representation of the described method is selected, in which method steps a), b) and c) are carried out for each data processing step 2 respectively. The actual data processing steps 2 are always carried out redundantly to each other, with first data processing module 5 and with second data processing module 6. Subsequently, with comparator module 7 a check is carried out in each case as to whether data processing step 2 was executed correctly before a next data processing step 2 is started.

1-13. (canceled)

14. A data processing network for a redundant and validated carrying out of a plurality of successive data processing step, each of which is used to generate output data from input data, output data of a first data processing step being at least partially simultaneously input data of a further data processing step, the data processing network comprising:
at least a first data processing module and a second data processing module, each configured to carry out each of the data processing steps; and
a comparator module, the first data processing module and the second data processing module being configured to transmit control parameters of the data processing steps to the comparator module, and the comparator module being configured to carry out at least one comparison of corresponding control parameters that were transmitted by the first data processing module and the second data processing module and, based on the comparison, to provide at least one synchronized control parameter that contains an item of control information relating to at least one data processing step that has been carried out.

15. The data processing network as recited in claim 14, wherein the comparison of the control parameters includes an identity check, and each synchronized control parameter requires an identity of the control parameters from the first data processing module and the second data processing module.

16. The data processing network as recited in claim 14, wherein the data processing network is configured to use the at least one synchronized control parameter provided by the comparator module to control a further data processing of the output data with further data processing steps of the data processing network.

17. The data processing network as recited in claim 14, wherein the at least one synchronized control parameter is a validity parameter that contains an item of validity information relating to least one of the data processing steps that has been carried out.

18. The data processing network as recited in claim 14, further comprising:
at least one sequentialization module configured to sort and to synchronize the control parameters from the first and second data processing modules and/or the data processing steps respectively, and to then forward these with a sorting to the comparator module, so that the comparator module can ascertain the synchronized control parameters independently of an order in which the first and second data processing modules have executed the data processing steps.

19. The data processing network as recited in claim 14, wherein the first data processing module is realized with first hardware components and the second data processing module is realized with second hardware components, the first hardware components and the second hardware components being physically separated from each other.

20. The data processing network as recited in claim 19, wherein at least one of the first and second data processing modules has a hardware component that is not ASIL-D compliant.

21. The data processing network as recited in claim 19, wherein the comparator module is realized with third hardware components which are physically separated from the first hardware components and the second hardware components.

22. The data processing network as recited in claim 21, wherein the third hardware components are ASIL-D compliant.

23. The data processing network as recited in claim 14, wherein the comparator module has a data memory in which ascertained control parameters are stored with items of time information, so that a logical timeline is produced that maps a sequence of processing of the data processing steps with the first and second data processing modules of the data processing network.

24. The data processing network as recited in claim 14, wherein a hardware component of the first and second data processing modules is significantly more powerful than a hardware component of the comparator module.

25. The data processing network as recited in claim 14, wherein the comparison of the control parameters includes a check of whether an error occurring during data processing in the first data processing module and/or in the second data processing module is below a tolerance limit, and the synchronized control parameter being generated.

26. A method for operating a data processing network, comprising the following steps:
a) carrying out a data processing step with a first data processing module and generating a first control parameter that is suitable for checking the carrying out of the data processing step with the first data processing module;
b) independently of step a), carrying out the same data processing step with a second data processing module and generating a second control parameter that is suitable for checking the carrying out of the data processing step with the second data processing module;
c) carrying out, with a comparator, a comparison of corresponding control parameters that were transmitted by the first data processing module and the second data processing module, and, based on the comparison, providing at least one synchronized control parameter that contains an item of control information relating to at least one data processing step that was carried out.
